(19) United States
(12) Patent Application Publication
(10) Pub. No.: US 2008/0054995 A1
(43) Pub. Date: Mar. 6, 2008

(54) PROGRAMMABLE DETECTION ADJUSTER

(75) Inventor: Yu-Tong Lin, Chutung Town (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: PHISON ELECTRONICS CORP., Chutung Town (TW)

(21) Appl. No.: 11/468,301

(22) Filed: Aug. 30, 2006

(51) Int. Cl. G05F 1/10

(52) U.S. Cl. 327/539

(57) ABSTRACT

A programmable detection adjuster is disclosed. The programmable detection adjuster comprises a bandgap and an adjusting circuit. The bandgap comprises a power input terminal, a voltage output terminal, a main resistance and a plurality of resistors. The adjusting circuit comprises a plurality of adjusting resistors, a plurality of transistor switches, a logic controller and detection circuits; said adjusting resistors connected to the main resistance of the bandgap in series. The adjusting resistors are respectively connected to the transistor switch in parallel. The transistor switches are connected to the logic controller. The logic controller is respectively connected to the detection circuits. The detection circuit detects the corresponding resistances in the detection circuit and outputs a voltage level to the logic controller to enable the logic controller to control a conduction of the transistor switches according to a logic conversion table.

### BACKGROUND OF THE INVENTION

1. Field of Invention

The present invention relates to a programmable detection adjuster, more particularly to a detection circuit for detecting corresponding resistance in the detection circuit to control a conduction of the transistor switches regardless of whether or not the fuse in the detection circuit is burnt out. Thus, the logic controller can output “on” or “off” signal to the corresponding transistor switches according to the signal and the logic conversion table.

2. Description of the Related Art

The trend of the semiconductor industry nowadays is heading towards design and developments of the consumer, computer and communication product and the system on chip are most desirable. The purpose is to reduce the cost, increase efficiency and reduce power consumption, and also to develop lighter, thinner, shorter and smaller portable electronic devices, which may be possible by adopting a more precise design technology and better process. The present chip unit can carry several chips, and integration of various elements is at a remarkable progress.

The chips on the circuit need a reference voltage generator for generating the reference voltage, for example, the reference voltage is based on the expectation of excellent temperature stability and a stable voltage supply. In other words, an effective separation is required to be apart from external environment. However, the reference voltage generator may have output voltage deviation due to the difference of the semiconductor process conditions. Therefore, for solving the deviation, some manufacturers propose using a plurality of small resistors connected to a main resistor. Referring to FIGS. 1 and 2, a fine adjusting circuit B is connected to a main resistance A1 of the reference voltage generator circuit A. The fine adjusting circuit B comprises a plurality of resistance B1 connected to the main resistance A1 in series, and the resistors B1 are respectively connected fuses B2 in parallel. Thus, the resistances B1 can fine adjust the absolute value of the main resistance A1 according to the status of the fuses B2 connected to the resistances B1.

However, to overcome the above defects, a new detection adjusting circuit is designed and comprises a plurality of adjusting resistances connected to a main resistance of a bandgap in parallel. The resistors are respectively connected to transistor switches and the logic controller in parallel. The logic controller is adopted to control the correspond transistor switch according to the logic conversion table and the received voltage level and transmits a voltage level signal, namely “0” for burnt out and “1” for non-burnt out, to the logic controller for turning on or off the transistor switches.

The above conventional bandgap has the following defects.

1. The conventional reference voltage generating circuit A can only burn out the fuse B2 but not increase the fuse B2 after the chip is formed. Therefore, for fine adjusting the positive and negative terminals, the fuses B2 should not burn out before the chip is treated. Accordingly, the output voltage A2 of the reference voltage generator circuit A is low, as shown in FIG. 2.

2. The conventional fuse B2 is burnt out by the current, and when the current is controlled inappropriately, the reference voltage generator circuit A may get damaged.

3. In the above detection adjuster, the fuse B2 must be burnt out or not in order to obtain a “0” or “1” signal. Therefore, the chip before packaging is treated, otherwise the “0” or “1” setup cannot precisely meet the requirement.

Therefore, to how to overcome the conventional defects described above is an important issue for manufacturers in the field.

### SUMMARY OF THE INVENTION

According to an aspect of the present invention, the logic controller in the adjusting circuit is used to control the transistor switch to output “on” or “off” signal to fine adjust the main resistance of the bandgap. Thus, the output voltage of the bandgap will not be lower before the fine adjustment of the main resistance.

According to another aspect of the present invention, the resistance and the detection circuit are compared regardless of the status of the fuse. Therefore, only the corresponding logic controller is adjusted according to the requirement before manufacturing the programmable detection adjuster that can simplify the process of material preparation.

### BRIEF DESCRIPTION OF THE DRAWING

FIG. 1 is a block diagram of a conventional bandgap.

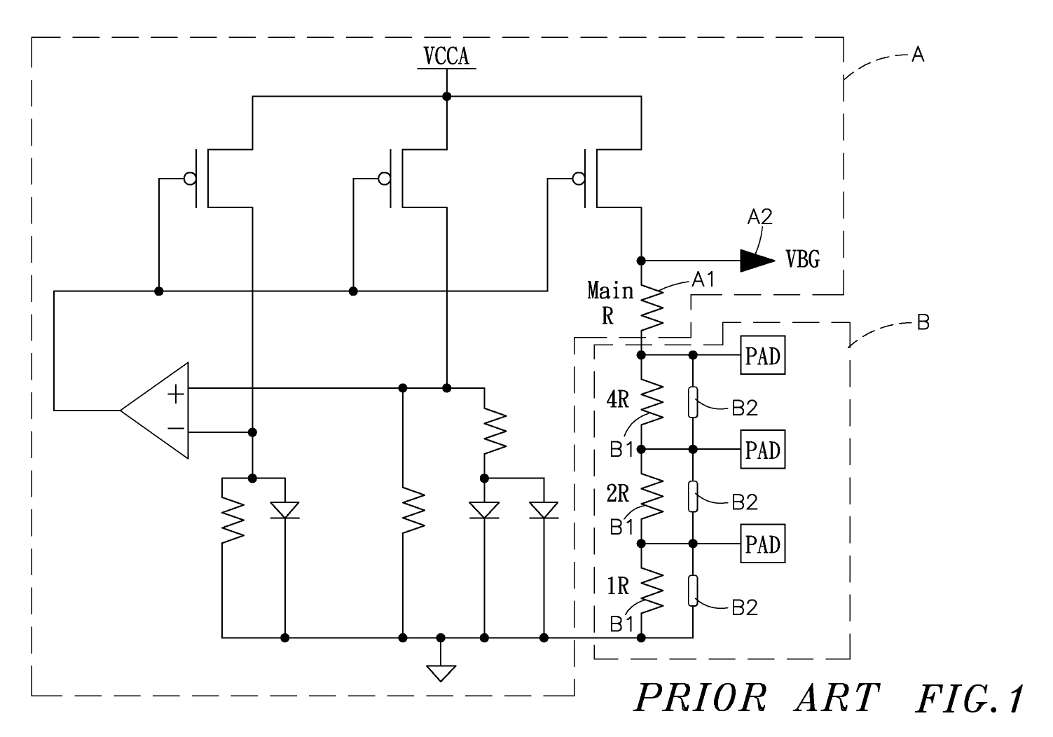

FIG. 2 is a voltage output table of a conventional bandgap.

FIG. 3 is a circuit diagram of a programmable detection circuit according to an embodiment of the present invention.

FIG. 4 is a circuit diagram of a programmable detection circuit according to a first embodiment of the present invention.

FIG. 5 is a circuit diagram of a programmable detection circuit according to a second embodiment of the present invention.

FIG. 6 is a circuit diagram of a programmable detection circuit according to a third embodiment of the present invention.

### DETAILED DESCRIPTION OF THE INVENTION

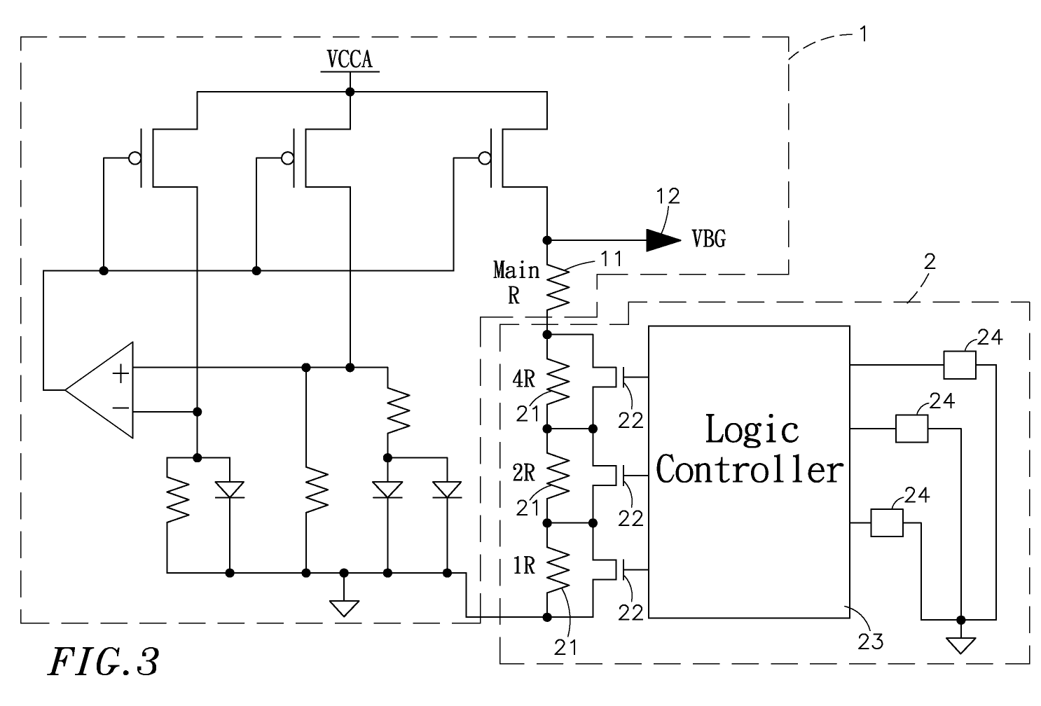

Referring to FIG. 3, programmable detection adjuster of the present invention comprises a bandgap 1 and an adjusting circuit 2. The bandgap 1 comprises a main resistance 11 connected to the adjusting circuit 2. The adjusting circuit 2 comprises a plurality of adjusting resistors 21 connected to the main resistance 11 in series. Each adjusting resistor 21 is connected to a transistor switch 22 in parallel, wherein the transistor switches 22 are connected to a logic controller 23. The logic controller 23 is connected to a plurality of detection circuits 24 in an orderly manner, and the number of the detection circuits 24 is same as the number of the transistor switches 22.

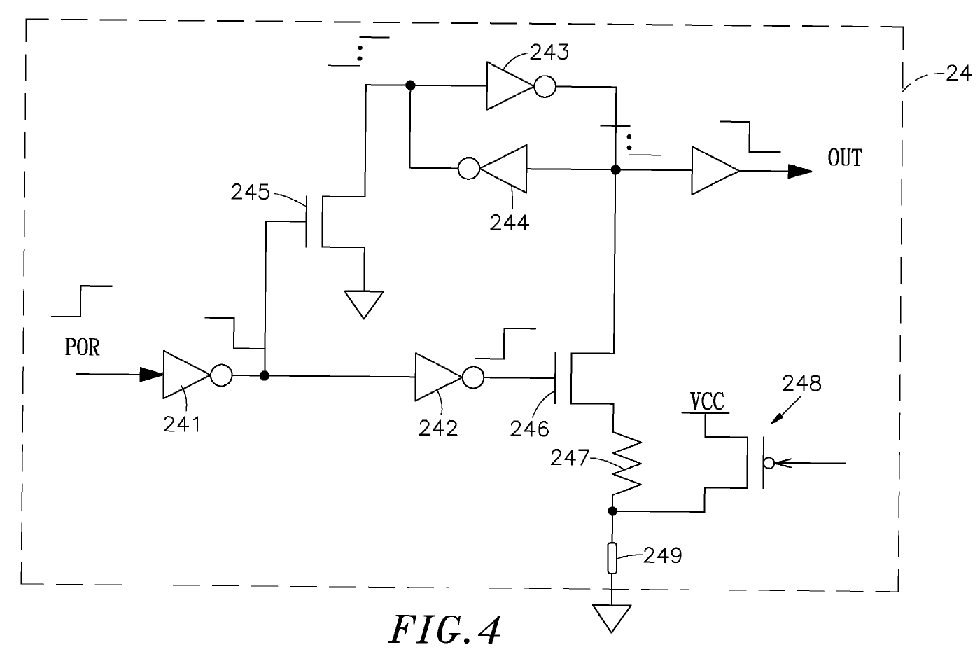

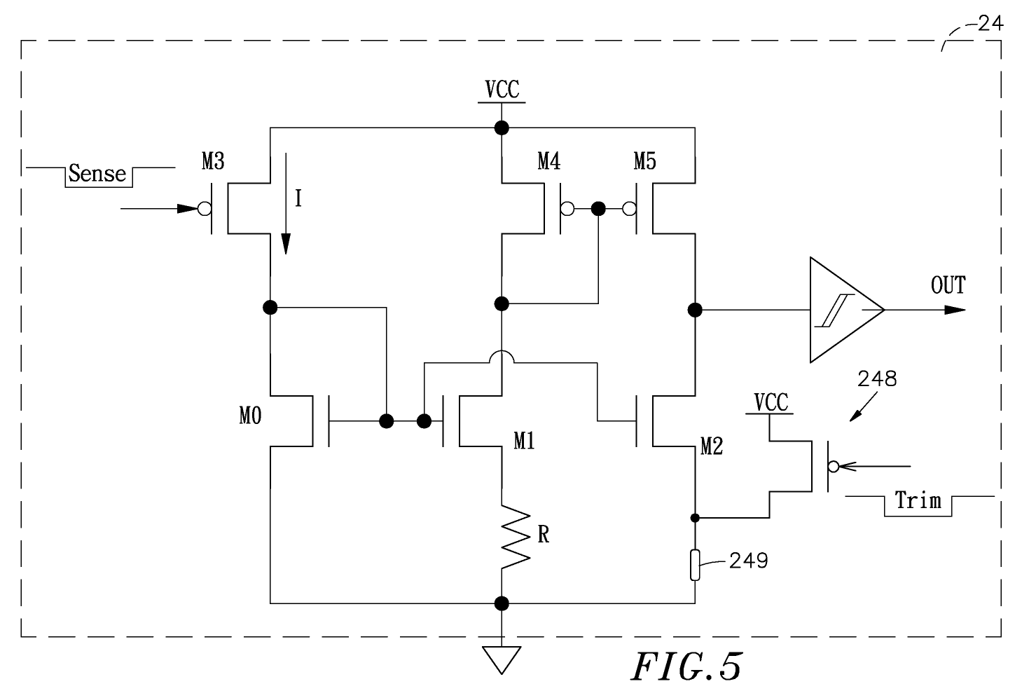

Referring to FIGS. 3 and 4, when an output voltage (VBG) 12 from the bandgap circuit 1 is fine adjusted by the adjusting circuit 2, every detection circuit 24 detects whether or not a fuse 249 is burn out and whether or not a large current flows through the fuse 249 from a third transistor switch 248. If the fuse 249 is burnt out, the detection circuits 24 output a high level voltage to the logic controller 23; otherwise, the detecting circuits 24 output a low level voltage to the logic controller 23. Besides, whether or not to burn out the fuse 249 depends upon the on/off status of the third transistor switch 248, however, the current flowing through the fuse 249 is limited by the third transistor switch 248, wherein if the current is not sufficient to burn out the fuse 249, the detection circuit 24 shown in FIG. 5 judges whether or not to correspondingly increase a resistance 247 in the detecting circuit 24 to decide to output the low level voltage or the high level voltage to the logic controller 23. Thus the output of the bandgap 1 is not affected regardless whether or not the fuse 249 burnt out.

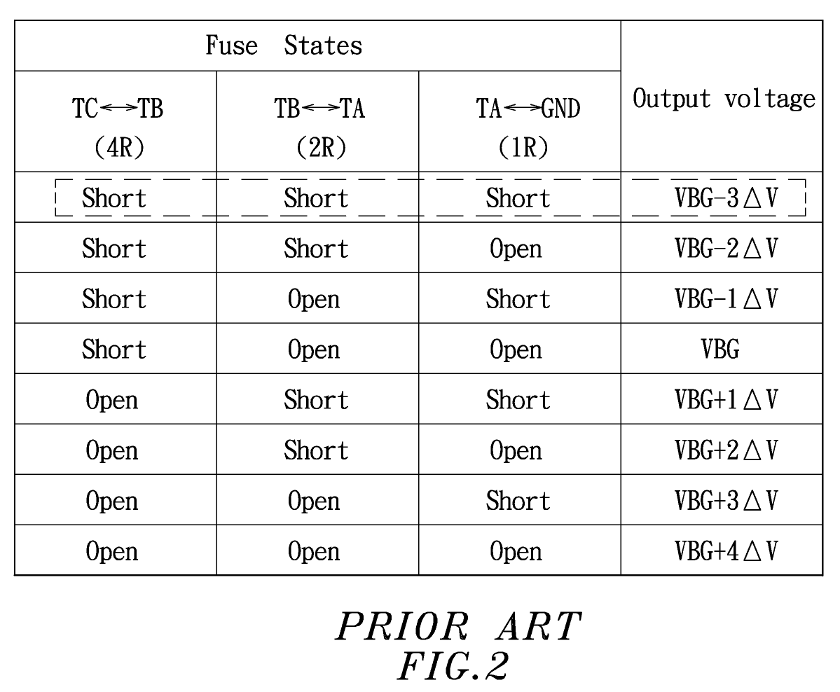

When the logic controller 23 receives a voltage level signal, the logic controller 23 will convert the voltage level signal according to a logic conversion table to control the on/off of the transistor switch 22 for adjusting the current through the transistor switch 22. Thus, the main resistance 11 of the bandgap 1 can fine adjust the absolute value of the main resistance 11 by using the adjusting resistors 21. Accordingly, the logic controller 23 uses the adjustment table shown in FIG. 2 to adjust on/off of the transistor switch 22 before a chip is treated to avoid an output voltage 12 of the bandgap 1 being overly low while the chip is never treated with all the fuses.

Furthermore, the transistor switch 22, a first transistor switch 245, a second transistor switch 246 and the third transistor switch 248 of the present invention may be comprised of NMOS, PMOS or any device with equivalent functionality to achieve the purpose of the present invention shall also be construed to be within the scope of the present invention.

Referring to FIGS. 3 and 4, the detection circuit 24 comprises a first inverter 241 connected to an output terminal of a second inverter 242 and the first transistor switch 245. A source of the first transistor switch 245 is respectively connected to an input terminal of a third inverter 243 and an output terminal of a fourth inverter 244. An output end of the second inverter 242 is connected to the second transistor switch 246, and a source of the second transistor switch 246 is respectively connected to an output terminal of the third inverter 243 and an input terminal of the fourth inverter 244. A drain of the second transistor switch 246 is connected to the resistance 247, and the resistance 247 is connected to a source of the third transistor switch 248. When it is determined that the fuse 249 is not burnt out or the resistance of the third transistor switch 248 is not increased, as shown in FIG. 4, the detection circuit 24 outputs a low level voltage to the logic controller 23 and the logic controller 23 to switch on or off the corresponding transistor switches 22 according to a logic conversion system together with the corresponding detection level signal in order to control the current through the transistor switches 22. Thus, the main resistance 11 of the bandgap 1 can fine adjust the absolute value of the main resistance 11 by using the adjusting resistors 21.

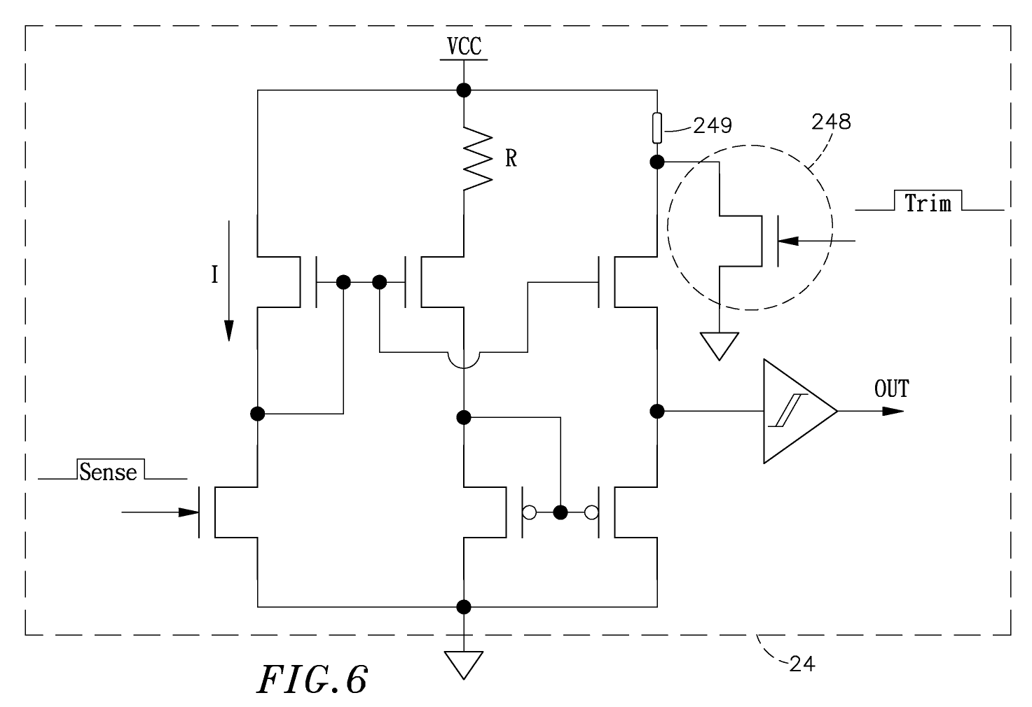

Referring to FIG. 5, because existence of the current gain, when the detection circuit 24 detects a large current flowing through the M3, and if the resistance value of the fuse 249 is smaller than the resistance R, the current flowing through the M2 is larger than the current flowing through the M1, and the current from the M1 flows through the current gain of M4 to the M5. Therefore, the current of the M5 is smaller than the M2 and thus the logic controller 23 outputs “0” or “off” signal. On the other hand, if the resistance value of the fuse 249 is larger than the resistance R, the logic controller 23 outputs “1” or “on” signal. Furthermore, referring to FIG. 6, according to the above circuit arrangement and the current gain, the third transistor switch 248 and the fuse 249 can be disposed in the power supply terminal to achieve non-differential voltage adjustment functionality.

Accordingly, the programmable detection adjuster of the present invention has the following advantages.

1. The adjusting circuit 2 of the present invention has a plurality of the adjusting resistors 21 in series and the adjusting resistors 21 are connected to the transistor switches 22 in parallel. The transistor switches 22 are also connected to the logic controller 23, and when the logic controller 23 receives a detection level, the logic controller 23 outputs “0” or “1” signal to the corresponding transistor switches 22 according to the logic conversion table to control the conduction of the transistor switches 22, and also enable the main resistance 11 of the bandgap 1 to fine adjust the absolute value thereof by using the adjusting resistors 21 of the adjusting circuit 2 to prevent the bandgap 1 output overly low voltage.

2. The adjusting circuit 2 of the present invention detects whether or not the fuse 249 is burnt out and any corresponding increase in the resistance 247 of the detection circuit 24 and output a voltage level to the logic controller 23 to enable the logic controller 23 to control the conduction of the transistor switches 22. When the fuse 249 is burnt out, because the detection circuit 24 is not directly connected to the bandgap 1 and therefore the current burning out the fuse 249 can be controlled, and the bandgap 1 will not be damaged to cause invalidation.

3. The detection circuit 24 and the logic controller 23 of the present invention is used to fine adjust the absolute value of the main resistance 11 of the bandgap 1, thus the number of PAD need not be increased and thereby avoid any additional space occupation.

4. The detection circuit 24 of the present invention is used to inspect any corresponding increase of the resistance in the detection circuit 24. Thus, the logic controller 23 can accurately judge to output “on” or “off” signal to the transistor switch 22 according to the status of the fuse 249 in the detection circuit 24. Accordingly, if the resistance of the fuse 249 in the detection circuit 24 is increased, the need of the user can be satisfied in a way to solve the problem of the material preparation.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A programmable detection adjuster, comprising:
a bandgap, comprising a power input terminal, an voltage output terminal, a main resistance and a plurality of amplifiers; and
a adjusting circuit, comprising a plurality of adjusting resistors, a plurality of transistor switches, a logic controller and detection circuits; wherein said adjusting resistors being connected to said main resistance of said bandgap in series; said adjusting resistors being respectively connected to said transistor switch in parallel; said transistor switches being connected to said logic controller; said logic controller being respectively connected to said detection circuits and a number of said detection circuits being the same as said transistor switches; wherein said detection circuit can detect corresponding relationship of resistances in said detection circuit and outputs a voltage level to said logic controller to enable said logic controller to control a conduction of said transistor switches according to a logic conversion table.

2. The programmable detection adjuster according to claim 1, wherein said detection circuit comprises a plurality of inverters, a plurality of transistor switches, a plurality of resistances and a plurality of fuses, wherein said resistances are connected to a sources of said transistor switches, and a corresponding relationship existences between a resistance of said transistor switch and a resistance of said detection circuit regardless of whether or not said fuses are burnt out so that said logic controller outputs “on” or “off” signal to the corresponding transistor switches according to the received level signal and a logic conversion system.

3. The programmable detection adjuster according to claim 2, wherein said resistance of said detection circuit is connected to a source of said transistor switches; a drain of said transistor switch is connected to a power supply; and said sources of said transistor switches are connected to said fuses.

4. The programmable detection adjuster according to claim 2, wherein said transistor switches and said fuses of said detection circuit can be installed in a power supply terminal or an output terminal.

5. The programmable detection adjuster according to claim 1, wherein said logic controller judges whether or not to send out a “0” or “1” signal according to a corresponding increase of said resistance in said detection circuit and said transistor switches and thereby decide whether or not to conduct said corresponding transistor switch in said adjusting circuits.

6. The programmable detection adjuster according to claim 1, wherein said transistor switches of said adjusting circuit comprise a NMOS or a PMOS.

7. The programmable detection adjuster according to claim 1, wherein said transistor switches of said detection circuit comprises a NMOS or a PMOS.
